(19) United States
(12) Patent Application Publication
(10) Pub. No.: US 2006/0271955 A1
(43) Pub. Date: Nov. 30, 2006

(54) Program information display device

(76) Inventors: Kentaro Saito, Osaka (JP); Taku Matsuda, Nara (JP); Yuki Kobayashi, Osaka (JP)

Correspondence Address: RATNERPRESTIA, P.O. BOX 980, VALLEY FORGE, PA, 19482, US

(21) Appl. No.: 10/553,901

(22) PCT Filed: May 26, 2004
(86) PCT No.: PCT/JP04/07580

§ 371 Date: Oct. 21, 2005

(30) Foreign Application Priority Data
May 27, 2003 (JP) 2003-148726

(51) Int. Cl. H04N 5/445; G06F 3/00; G06F 13/00

(52) U.S. Cl. 725/45; 725/40; 725/39

(57) ABSTRACT

A program information display device is capable of using an electronic program guide using arbitrary attributes as axes of scatter diagram displaying program information, and allowing to find a desired program easily. Also, a program information display device has an electronic program guide capable of displaying program information at high degree of freedom without restriction of discrete layout. The program information display device is a program information display device for displaying program information in a scatter diagram disposed at a position conforming to related value about attribute of X-axis and related value about attribute of Y-axis, comprising program information storage, program information processing, program information display, and attribute input.

### TECHNICAL FIELD

The present invention relates to a program information display device for presenting an electronic program guide (EPG).

### BACKGROUND ART

The number of broadcast programs is increasing recently owing to development in satellite broadcast, ground wave broadcast, wired broadcast, etc., and the number of programs received by receiver is expected to increase further. Among the multi-channel trend, it is difficult for the viewer to find out a desired program easily.

In this background, the prior art for presenting program information easily and efficiently to the viewer includes a program information processing device comprising program information storing means for storing program information, and program guide display means for displaying a program guide two-dimensionally according to the X-axis and Y-axis depending on two attributes among the attributes attached to the program information, in which the program guide is created by two-dimensional display of program using free attributes as X-axis and Y-axis. Such prior art is disclosed, for example, in Japanese Patent Application Laid-Open Publication No. 11-25541.

### DISCLOSURE OF THE INVENTION

The program information display device is:

a program information display device for displaying a scatter diagram by plotting two arbitrary attributes selected by the viewer from at least two attributes relating to a program on the X-axis and Y-axis, and disposing the program information at a position conforming to the related value about the X-axis attribute and the related value about the Y-axis attribute, comprising:

program information storing means;

program information processing means;

program information display means; and

attribute input means,

in which the program information storing means stores a related value numerically expressing the degree of relation about at least one program information and at least two attributes of program information,

the attribute input means acquires a first attribute used as X-axis of scatter diagram and a second attribute used as Y-axis,

the program information processing means acquires the first attribute and the second attribute from the attribute input means, and also acquires the program information, related value about first attribute and related value about second attribute from the program information storing means, and

the program information display means acquires the program information, the first attribute, the second attribute, related value about first attribute and related value about second attribute from the program information processing means, plots the first attribute and second attribute on the X-axis and Y-axis of scatter diagram respectively, and displays the program information at a position conforming to the related value about the first attribute and the related value about the second attribute of the scatter diagram.

### BRIEF DESCRIPTION OF THE DRAWINGS

FIG. 1 is a block diagram of configuration of first preferred embodiment of the invention.

FIG. 2 is a data structure diagram showing selected examples of program information stored in the program information storing means.

FIG. 3 is a data structure diagram showing selected examples of program information shown in scatter diagram stored in the program information processing means.

FIG. 4 is a scatter diagram showing display operation in first preferred embodiment of the invention.

FIG. 5 is a block diagram of configuration of second preferred embodiment of the invention.

FIG. 6 is a scatter diagram showing display operation in second preferred embodiment of the invention.

FIG. 7 is a block diagram of configuration of third preferred embodiment of the invention.

FIG. 8 is a scatter diagram showing display operation in third preferred embodiment of the invention.

FIG. 9 is a block diagram of configuration of fourth preferred embodiment of the invention.

FIG. 10 is a data structure diagram showing selected examples of setting information of information quantity of program information stored in program information processing means in fourth preferred embodiment of the invention.

FIG. 11 is a scatter diagram of display operation when the number of program information items to be displayed is 10 in fourth preferred embodiment of the invention.

FIG. 12 is a scatter diagram of display operation when the number of program information items to be displayed is 5 in fourth preferred embodiment of the invention.

FIG. 13 is a block diagram of configuration of fifth preferred embodiment of the invention.

FIG. 14 is a scatter diagram showing display operation in fifth preferred embodiment of the invention.

FIG. 15 is a block diagram of configuration of sixth preferred embodiment of the invention.

FIG. 16 is a scatter diagram showing display operation in sixth preferred embodiment of the invention.

FIG. 17 is a block diagram of configuration of seventh preferred embodiment of the invention.

FIG. 18 is a data structure diagram showing selected examples of program information to be displayed in the scatter diagram stored in the program information processing means in seventh preferred embodiment of the invention.

FIG. 19 is a scatter diagram showing display operation in seventh preferred embodiment of the invention.

### DETAILED DESCRIPTION OF THE PREFERRED EMBODIMENTS

In the conventional configuration, however, since the program information is displayed in a predetermined frame of a table, and the display is limited to discrete layout only, and the degree of freedom of display is small.

The invention is devised to solve the problems of the prior art, and it is hence an object thereof to present a program information display device allowing the viewer to find out a desired program easily, and capable of displaying the program information at high degree of freedom of display as compared with program table.

Preferred embodiments of the invention are described below while referring to the accompanying drawings.

### Preferred Embodiment 1

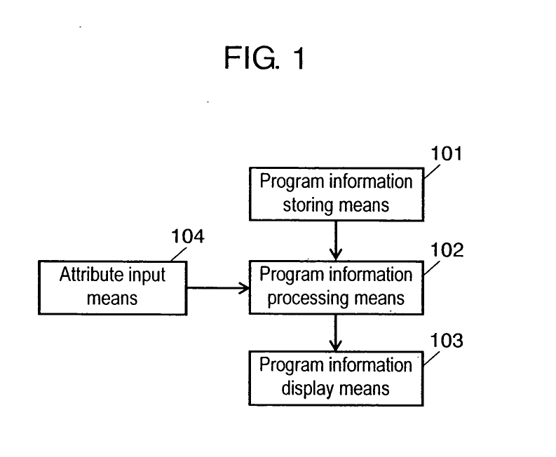

FIG. 1 is a block diagram of configuration of first preferred embodiment of program information display device of the invention. As shown in FIG. 1, the program information display device of the invention comprises program information storing means 101, attribute input means 104, program information processing means 102, and program information display means 103. The program information storing means 101 stores the program information and numerical information of related value with program attribute. The attribute input means 104 acquires first attribute for X-axis of scatter diagram and second attribute for Y-axis. The program information processing means 102 acquires first attribute for X-axis of scatter diagram and second attribute for Y-axis from the attribute input means 104. The program information processing means 102 acquires related value about first attribute of program information, related about second attribute, and program information to be displayed in scatter diagram, from the program information storing means 101. The program information display means 103 acquires the program information, first attribute, second attribute, related value about first attribute, and related value about second attribute, from the program information processing means 102. Plotting the obtained two attributes on the X-axis and Y-axis, a scatter diagram is drawn. Further, the program information display means 103 displays the program information and icons in the scatter diagram, by disposing at a position conforming to the X-axis attribute value and Y-axis attribute value.

Information stored in the program information storing means 101 is acquired by using broadcast wave, wired broadcast, wireless communication, or wired communication. Two attributes to be entered in the attribute input means 104 are entered by the viewer from a portable terminal or an input device attached to the equipment incorporating the program information display device of the invention. Such portable terminal includes PDA (personal digital assistant), remote controller, or cellphone. The monitor for displaying the scatter diagram includes television, computer monitor, and monitor attached to portable terminal. The portable terminal is PDA, remote controller or cellphone. Attribute items used on the axes of scatter diagram include channel, on-air time, program genre such as SF, romance, action, sports and news, viewing rate, popularity ranking, foreign movie, Japanese movie, year of manufacture, and other information related to program.

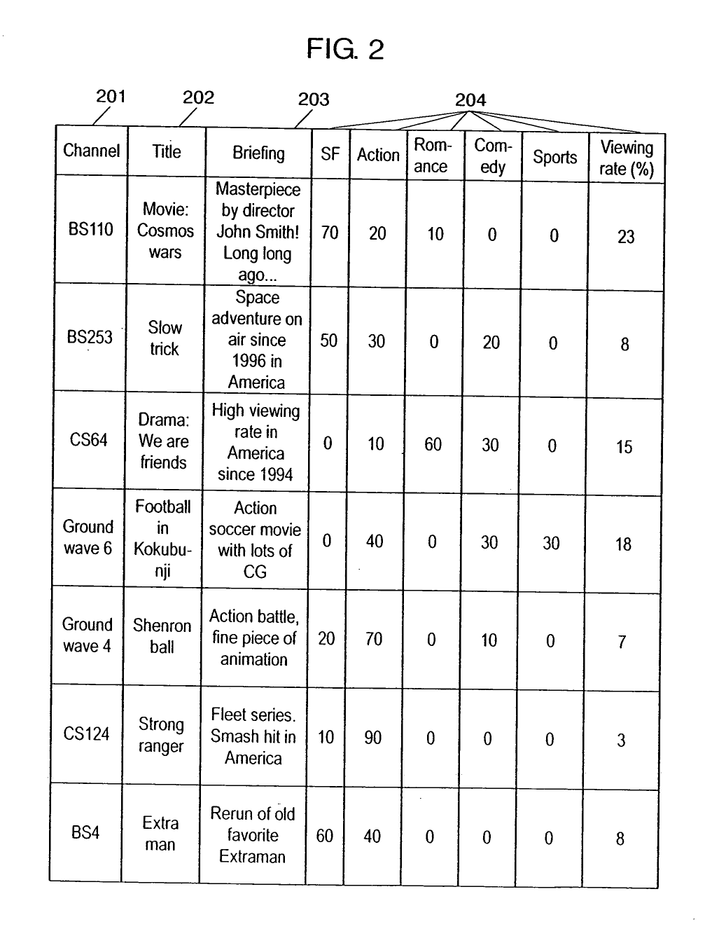

FIG. 2 is a data structure diagram showing selected examples of program information stored in the program information storing means 101 and related values about attributes of program information. Related values of each program are recorded, such as channel 201, title 202, briefing 203 and attribute 204. Program information, types of attributes, and number of registered program information items stored in the program information storing means 101 are not limited to the examples shown in FIG. 2, but, for example, thumbnail or other information may be stored in the program information.

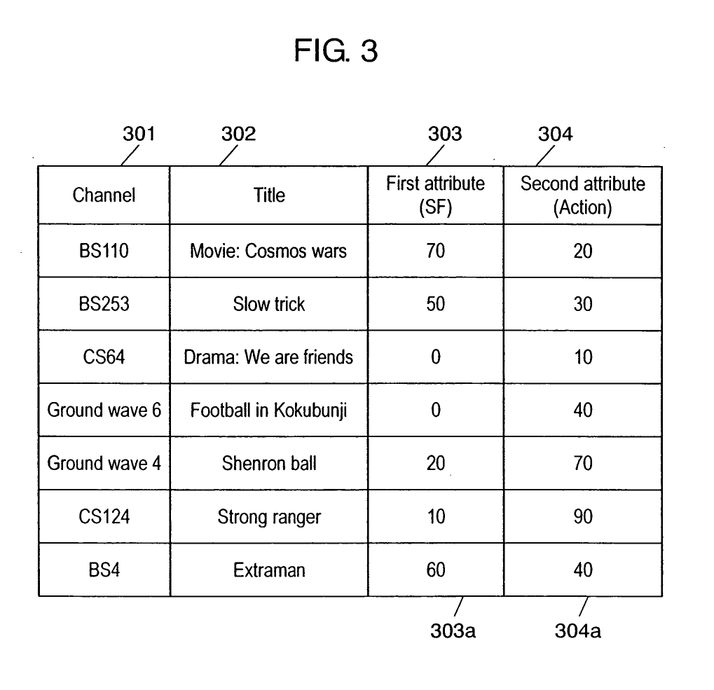

FIG. 3 is a data structure diagram of program information shown in scatter diagram stored in the program information processing means 102. First attribute 303 and second attribute 304 are acquired from the attribute input means 104, program channel 301, title 302, related value about first attribute 303, and related value about second attribute 304 are acquired from the program information storing means 101. In FIG. 3, the first attribute 303 is SF and the second attribute 304 are action, which are acquired from the attribute input means 104. Related value about first attribute and related value about second attribute of each program information are acquired from the program information storing means 101. For example, related value 303a about first attribute of Extraman in FIG. 3 is 60, and related value 304b about second attribute is 40. Data structure of program information is not limited to this example, and information such as program briefing or thumbnail may be included, and the number of attributes to be entered by the attribute input means 104 is not limited to 2

In the program information display device having such configuration, operation is described below. The viewer enters two attributes desired to be displayed on scatter diagram, that is, first attribute 303 and second attribute 304 in the program attribute input means 104. The program information processing means 102 acquires the first attribute 303 and second attribute 304 from the attribute input means 104, and further acquires program information such as channel 301 and title 302, and related value about first attribute 303 of program information and related value about second attribute 304 from the program storing means 101, and issues to the program information display means 103. The program information display means 103 acquires program information, first attribute, second attribute, related value about first attribute, and related value about second attribute, from the program information processing means 102. As a result, plotting the first attribute 303 on the X-axis and second attribute 304 on the Y-axis, a scatter diagram is drawn. Further, the program information display means 103 obtains the related value about first attribute 303 of program information as X-axis value, and the related value about second attribute 304 as Y-axis value, and displays the program information and icons at the position conforming to each axis value. The number of program information items to be displayed in the scatter diagram is not limited to 1.

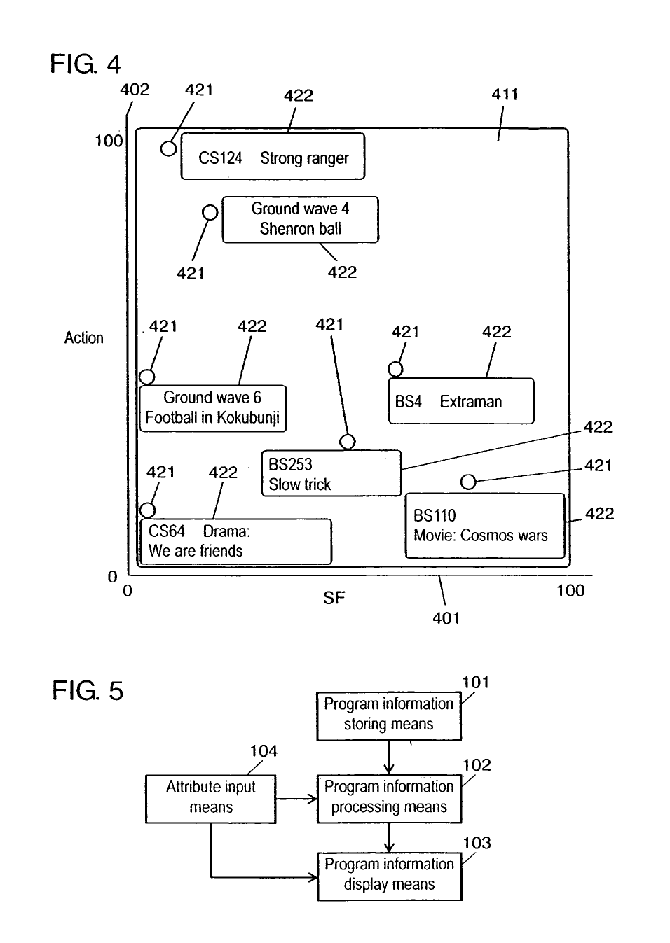

FIG. 4 is a scatter diagram showing display operation in first preferred embodiment. In the case of input of “SF” in the first attribute and “action” in the second attribute, the program information display means 103 compiles a scatter diagram by plotting “SF” on X-axis 401 and “action” on Y-axis 402 as shown in FIG. 4. In program information display area 411, icon 421 and program information 422 are displayed at positions conforming to the related value about each attribute of program information.

Thus, the viewer can look up the program information in the scatter diagram plotting two attributes desired by the viewer on two axes. Since the electronic program guide is displayed in a form of scatter diagram, as compared with program table, the layout is not limited to discrete layout, and program information high in degree of freedom can be displayed.

### Preferred Embodiment 2

FIG. 5 is a block diagram of configuration of second preferred embodiment of program information display device of the invention. In FIG. 5, attribute input means 104 acquires, aside from the operation shown in preferred embodiment 1 of the invention, display range of first attribute and display range of second attribute. The program information display means 103 acquires, aside from the operation shown in preferred embodiment 1, display range of first attribute and display range of second attribute from the attribute input means 104. As a result, the program information display means 103 displays the scatter diagram showing the display range of first attribute as X-axis display range, and display range of second attribute as Y-axis display range. In the second preferred embodiment, the configuration of the program information display device is same as in the first preferred embodiment.

In the program information display device having such configuration, operation is described below. The viewer enters the first attributes and its display range, and second attribute and its display range, as the attributes desired to be displayed in the scatter diagram in the program attribute input means 104. The program information processing means 102 acquires the first attribute to be used on the X-axis of scatter diagram and second attribute to be used on the Y-axis from the attribute input means 104. The program information processing means 102 further acquires program information to be displayed in the scatter diagram, related value about first attribute of program information and related value about second attribute from the program information storing means 101, and issues to the program information display means 103. The program information display means 103 acquires program information, first attribute, second attribute, related value about first attribute, and related value about second attribute, from the program information processing means 102. Further, the program information display means 103 acquires the display range of first attribute and display range of second attribute from the attribute input means 104. Plotting the first attribute on the X-axis and second attribute on the Y-axis, the program information display means draws a scatter diagram, in which the X-axis and Y-axis are displayed in display range of first attribute and display range of second attribute entered from the attribute input means 104. The program information display means 103 displays the icon and program information at positions conforming to the values of each axis, plotting the related value about the first attribute as X-axis value, and the related value about the second attribute as Y-axis value.

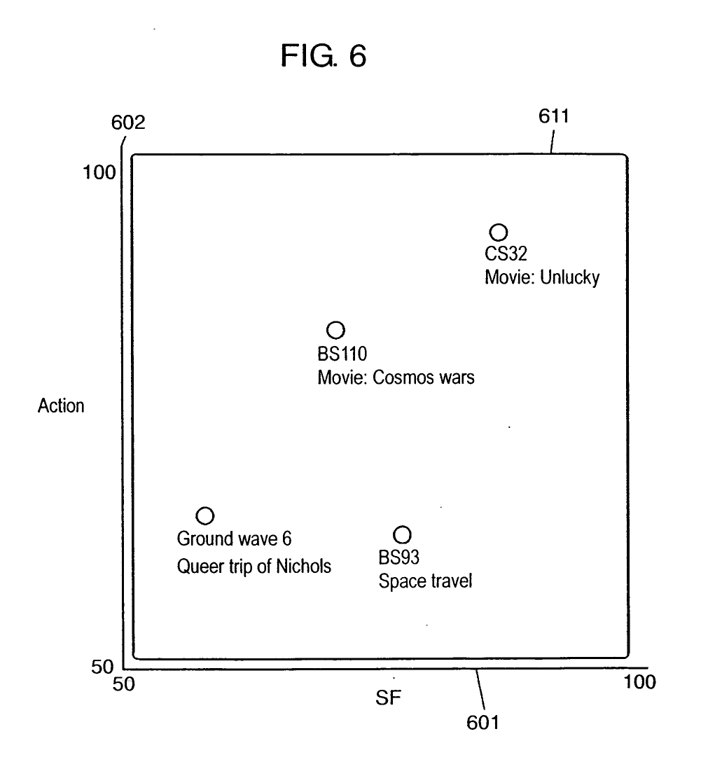

FIG. 6 is a scatter diagram showing display operation in second preferred embodiment. In the case of input of “SF” in the first attribute, 50 to 100 in its display range, and “action” in the second attribute, and 50 to 100 in its display range, the program information display means 103 displays a scatter diagram by plotting “SF” on X-axis 601 and “action” on Y-axis 602 as shown in FIG. 6. The program display means 103 displays each program information and icon in the program information display area 611 at a position conforming to the related value about each attribute. Herein, the display range is indicated by display range 50 to 100 entered in the attribute input means 104 on both axis of SF and axis of action. The procedure of displaying in the scatter diagram is not limited to this example alone, but, for example, the display range may be changed by entering the display range after displaying the scatter diagram by entering the first attribute and second attribute.

Thus, the viewer can see by changing the desired range of scatter diagram.

### Preferred Embodiment 3

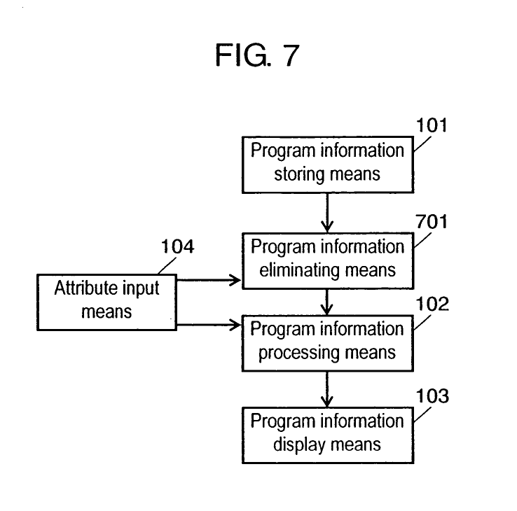

FIG. 7 is a block diagram of configuration of third preferred embodiment of program information display device of the invention. In FIG. 7, attribute input means 104 acquires, aside from the operation shown in preferred embodiment 1 of the invention, third attribute used as threshold for limiting the program information to be displayed in the scatter diagram, and limit value of third attribute. Program information eliminating means 701 acquires third attribute and limit value of third attribute from the attribute input means 104, and acquires program information and related value about attribute of program information from the program information storing means 101. Program information eliminating means 701 compares the related value of third attribute in each program information among them and limit value of third attribute entered from the attribute input means 104. As a result, the program information eliminating means 701 eliminates the program information having related value of third attribute of less than the limit value of third attribute and related value about attribute of program information, and stores the program information of the program having related value of third attribute of more than the limit value of third attribute and related value about attribute of program information. In the third preferred embodiment, other configuration of the program information display device is same as in the first preferred embodiment.

In the program information display device having such configuration, operation is described below. The viewer enters two attributes desired to be displayed as X-axis and Y-axis of scatter diagram, as first attribute and second attribute, in the program attribute input means 104, and enters third attribute and limit value of third attribute as thresholds when displaying program information. The program information eliminating means 701 acquires third attribute and limit value of third attribute from the attribute input means 104, and acquires program information and related value about attribute of program information from the program information storing means 101. Further, the program information eliminating means 701 compares the related value about the third attribute among the related values about the attributes acquired from the program information storing means 101, and the limit value of third attribute acquired from the attribute input means 104. As a result, when the related value about the third attribute is less than the limit value of the third attribute, the program information eliminating means 701 eliminates the corresponding program information and related value about the attribute of the program information. On the other hand, when the related value about the third attribute is more than the limit value of the third attribute, the corresponding program information and related value about the attribute of the program information are saved in the program information eliminating means 701. The program information processing means 102 acquires first attribute and second attribute from the attribute input means 104, and acquires the program information and related value about first attribute and related value about second attribute of program information from the program information eliminating means 701, and issues to the program information display means 103. The program information display means 103 acquires program information, first attribute, second attribute, related value about first attribute of program information, and related value about second attribute from the program information processing means 102. The program information display means 103 draws a scatter diagram by plotting the first attribute on the X-axis and the second attribute on the Y-axis, and obtains the related value about first attribute of program information as X-axis value and the related value about second attribute as Y-axis value, and displays the program information at a position conforming to the value of each axis of the scatter diagram.

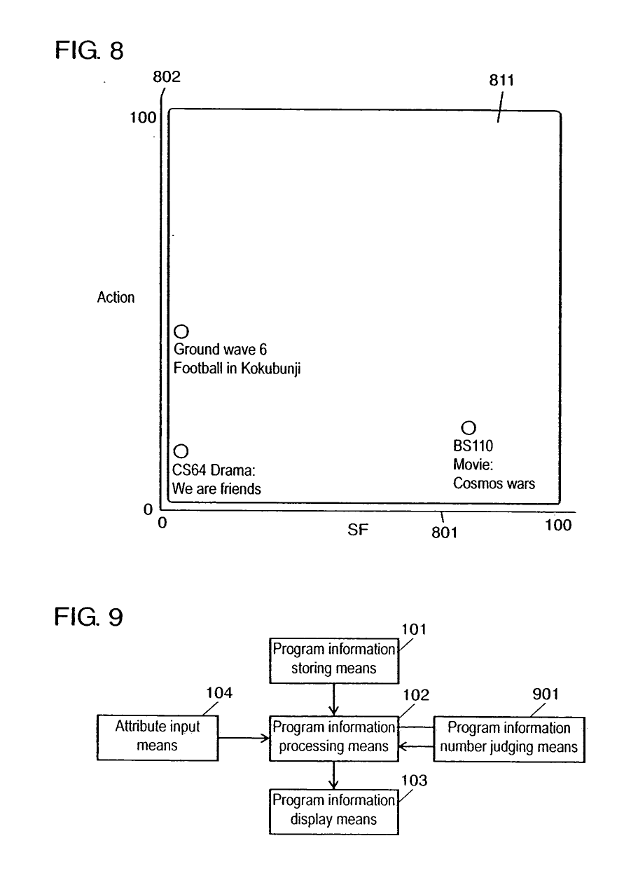

FIG. 8 is a scatter diagram showing display operation in third preferred embodiment. Herein, as example of data stored in the program information storing means 101, same data as in FIG. 2 is used. When the viewer enters SF in first attribute, action in second attribute, viewing rate in third attribute, and 10% in limit value of third attribute, only the program information of viewing rate of 10% or more is displayed in the scatter diagram, out of the program information shown in FIG. 2. That is, the program information storing means 101 compiles a scatter diagram of two axes, plotting SF on X-axis 801 and action on Y-axis 802 as shown in FIG. 8, and displays three types of program information, movie: Cosmo Wars, drama: We are friends, movie: Football at Kokubunji, in the scatter diagram in program information display area 811. Input sequence of first attribute, second attribute, third attribute, and limit value of third attribute is not particularly specified, and for example, after displaying the scatter diagram by entering the first attribute and second attribute, the third attribute and limit value of third attribute may be entered, and the program information less than the threshold of third attribute may be erased from the scatter diagram.

By thus reducing the program information to be displayed from the scatter diagram displaying multiple items of program information, the scatter diagram will be easier to see by the viewer.

### Preferred Embodiment 4

FIG. 9 is a block diagram of configuration of fourth preferred embodiment of program information display device of the invention. In FIG. 9, program information number judging means 901 acquires program information from the program information processing means 102, judges the number of program information items to be displayed in the scatter diagram, and issues the judged result to the program information processing means 102. The program information processing means 102 acquires, aside from the operation shown in preferred embodiment 1 of the invention, the judged result from the program information number judging means 901, and determines the information quantity of the program information to be issued to the program information display means 103 on the basis of the judged result. In this fourth preferred embodiment, other configuration of the program information display device is same as in the first preferred embodiment.

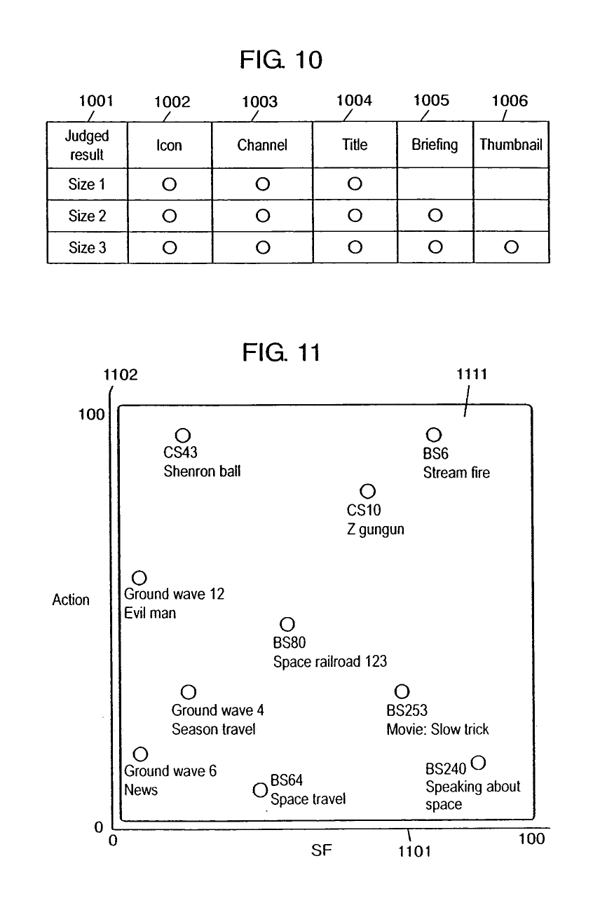

FIG. 10 shows a data structure storing setting information of information quantity of program information to be issued to the program display means stored in the program information processing means. For example, if the judged result 1001 of program information number is size 3, icon 1002, channel 1003, title 1004, briefing 1005, thumbnail 1006 are issued as program information to the program information display means 103. Herein, the judged result 1001 is obtained from the program information number judging means 901.

In the program information display device having such configuration, operation is described below. The viewer enters two attributes desired to be displayed as X-axis and Y-axis of scatter diagram, as first attribute and second attribute, in the program attribute input means 104. The program information processing means 102 obtains acquires the first attribute and second attribute from the attribute input means 104, and acquires program information and related value about first attribute and related value about second attribute from the program information storing means 101. The program information number judging means 901 acquires the program information from the program information processing means 102, and judged the number of program information items, and selects size 1 if the program information number exceeds 10, and issues the result to the program information processing means 102 as judged result. If the result is 5 or more but less than 10, size 2 is selected, and the result is issued to the program information processing means 102 as judged result. If less than 5, size 3 is selected, and the result is issued to the program information processing means 102 as judged result. The program information processing means 102 acquires the judged result from the program information number judging means 901, and if the judged result 1001 is size 1, icon 1002, channel 1003, and title 1004 are issued to the program information display means 103 as program information to be displayed in scatter diagram. If the judged result 1001 is size 2, the program information processing means 102 sends icon 1002, channel 1003, title 1004, and briefing 1005 to the program information display means 103 as program information to be displayed in scatter diagram. If the judged result 1001 is size 3, the program information processing means 102 sends icon 1002, channel 1003, title 1004, briefing 1005, and thumbnail 1006 to the program information display means 103 as program information to be displayed in scatter diagram. The program information display means 103 acquires the program information, first attribute, second attribute, related value about first attribute of program information, and related value about second attribute from the program information processing means 102. The program information display means 103 draws a scatter diagram by plotting the first attribute on the X-axis and second attribute on the Y-axis, and displays each program information at position conforming to the related value of first attribute and second attribute. The judged result determined by the program information number judging mean 901 is not limited to three types only. Classification of information quantity of program information issued to the program information display device 103 depending on the judged result is not specified as shown in FIG. 10. Branching points of program information number for determining the information quantity of program information to be displayed in the program information display means 103 are not limited to 5 and 10.

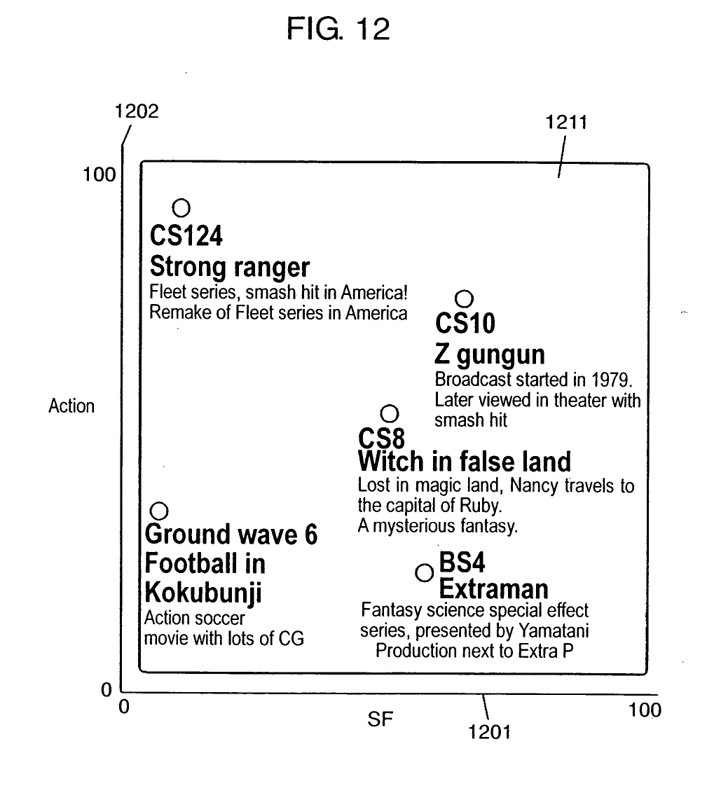

FIG. 11 and FIG. 12 are diagrams explaining the display operation of scatter diagram in the fourth preferred embodiment. By entering SF in the first attribute and action in the second attribute, when the number of program information items displayed in the scatter diagram is 10, as shown in FIG. 11, a scatter diagram is compiled on two axes, plotting SF on the X-axis 1101 and action on the Y-axis 1102. In the program information display area 1111, the icon, program channel, and title are displayed as program information. On the other hand, when the number of program information items displayed in the scatter diagram is 5, as shown in FIG. 12, a scatter diagram is compiled on two axes, plotting SF on the X-axis 1201 and action on the Y-axis 1202. The icon, program channel, title, and program briefing are displayed in the program information display area 1211.

Thus, the scatter diagram is easier to see by varying the information quantity of program information to be displayed depending on the number of program information items to be displayed on the scatter diagram.

In the foregoing explanation, the program information number judging means 901 is designed to judge the number of program information items to be displayed on the scatter diagram, but not limited to the number of program information items, it may be also designed to judge the display range of the scatter diagram.

### Preferred Embodiment 5

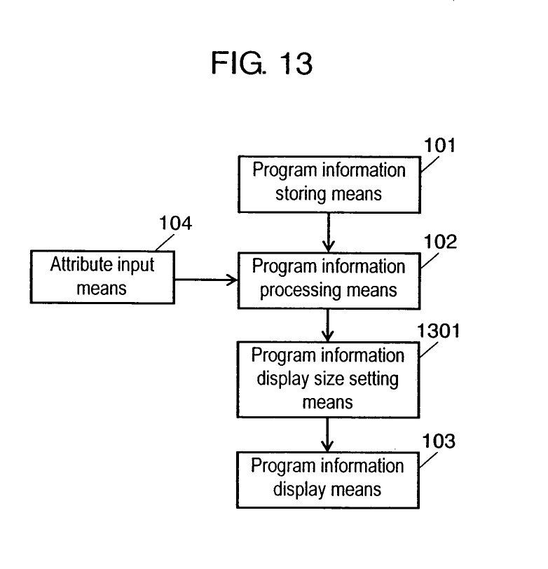

FIG. 13 is a block diagram of configuration of fifth preferred embodiment of program information display device of the invention. In FIG. 13, attribute input means 104 acquires third attribute used as parameter of character size to be displayed in the scatter diagram, aside from the operation shown in preferred embodiment 1 of the invention. Program information display size setting means 1301 acquires program information, first attribute, second attribute, third attribute, related value about first attribute of program information, related value about second attribute, and related value about third attribute, from the program information processing means 102. The program information size setting means 1301 determines the display size setting value of each program information from the related value about third attribute. The program information display means 103 acquires the display size setting value from the program information processing means 102, aside from the operation shown in preferred embodiment 1 of the invention, and displays the corresponding program information in the scatter diagram in the character size conforming to the setting value. In the fifth preferred embodiment, other configuration of the program information display device is same as in the first preferred embodiment.

In the program information display device having such configuration, operation is described below. The viewer enters two attributes desired to be displayed as X-axis and Y-axis of scatter diagram, as first attribute and second attribute, in the program attribute input means 104. The program information processing means 102 acquires the first attribute, second attribute, and third attribute from the attribute input means 104, and acquires program information and related value about first attribute, related value about second attribute, and related value about third attribute from the program information storing means 101, and sends out to the program information size setting means 1301. The program information size setting means 1301 acquires program information, first attribute, second attribute, third attribute, related value about first attribute of program information, related value about second attribute, and related value about third attribute, from the program information processing means 102. Further, the program information size setting means 1301 determines the display size setting value to be displayed in the scatter diagram from the related value about third attribute used as parameter of display size among the acquired data, and sends out the display size setting value, program information, first attribute, second attribute, related value about first attribute of program information, and related value about second attribute, to the program information display means 103. The program information display means 103 acquires the display size setting value, program information, first attribute, second attribute, related value about first attribute of program information, and related value about second attribute. Further, the program information display means 103 draws a scatter diagram by plotting the first attribute and second attribute on the X-axis and Y-axis respectively, and displays the program information in the character size conforming to the display size setting value, in the place conforming to the related value about first attribute of program information and related value about second attribute. The object to be changed by the program information size setting means 1301 is not limited to character size, but includes the information quantity of program information displayed in the scatter diagram, character color, icon size, icon shape, and icon color.

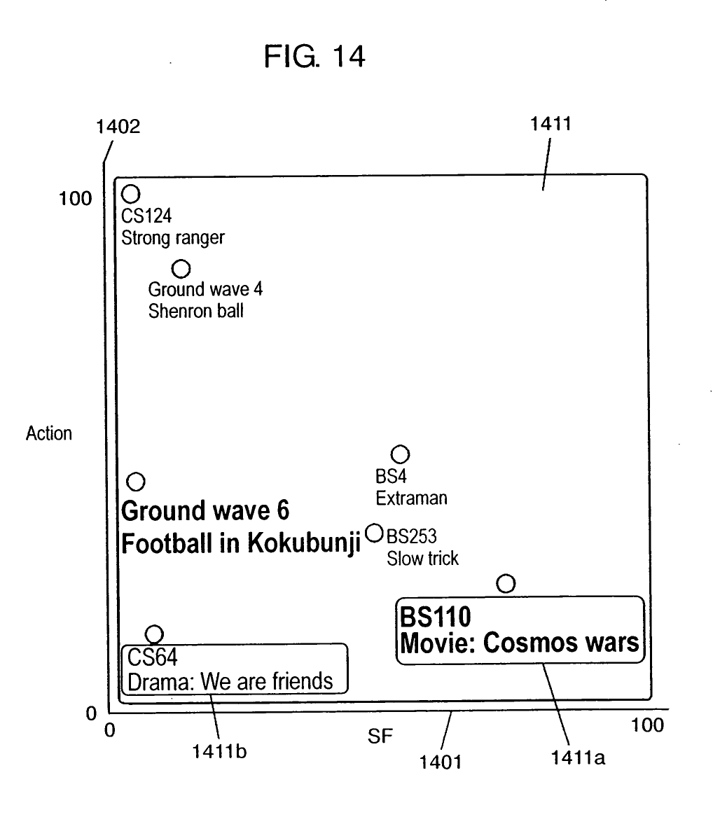

FIG. 14 is a diagram explaining the display operation of scatter diagram in the fifth preferred embodiment.

In FIG. 14, by entering SF in the first attribute, action in the second attribute, and viewing rate in the third attribute, in the attribute input means 104, the program information display means 103 displays a scatter diagram, plotting the SF on X-axis 1401 and action on Y-axis 1402. The program information display means 103 further displays each program information and icons in the program information display area 1411, in the place conforming to the related values about attributes. Among them, the “viewing rate” is displayed in the character size displayed in the scatter diagram. As shown in FIG. 14, the display size of program information 1411a (in the diagram, movie: Cosmos war) is larger than the display size of program information 1411b (in the diagram, drama: We are friends), and it means that the viewing rate of program information 1411a is higher than the viewing rate of program information 1411b.

Thus, the viewer can understand the three properties of the program by the two-dimensional scatter diagram.

### Preferred Embodiment 6

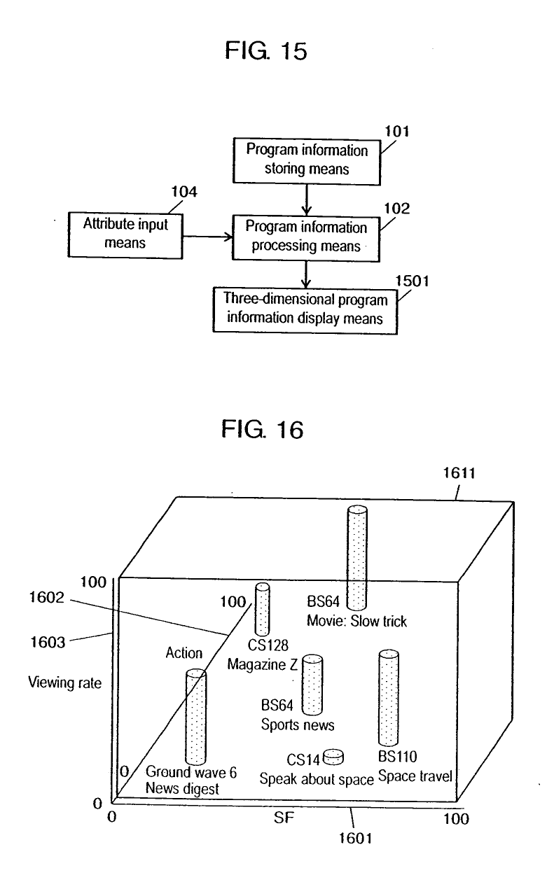

FIG. 15 is a block diagram of configuration of sixth preferred embodiment of program information display device of the invention. In FIG. 15, three-dimensional program information display means 1501 acquires program information, first attribute of program information, second attribute, and related value about third attribute, from the program information processing means 102. The three-dimensional program information display means 1501 draws and displays a three-dimensional scatter diagram, plotting the first attribute, second attribute, and third attribute on axes. In the sixth preferred embodiment, other configuration of the program information display device is same as in the first preferred embodiment.

In the program information display device having such configuration, operation is described below. The viewer enters first attribute, second attribute, and third attribute as axes of scatter diagram, in the program attribute input means 104. The program information processing means 102 acquires the first attribute, second attribute, and third attribute from the attribute input means 104, and acquires program information and related value about first attribute of program information, related value about second attribute, and related value about third attribute from the program information storing means 101. The three-dimensional program display means 1501 acquires program information, first attribute, second attribute, third attribute of program information, related value about first attribute, related value about second attribute, and related value about third attribute of program information, from the program information processing means 102. Further, the three-dimensional program display means 1501 draws a three-dimensional scatter diagram by plotting the first attribute, second attribute, and third attribute on the X-axis, Y-axis, and Z-axis respectively. Further the three-dimensional program display means 1501 displays the program information in the place conforming to the related value about first attribute of program information, related value about second attribute, and related value about third attribute.

FIG. 16 is a diagram explaining the display operation of scatter diagram in the sixth preferred embodiment. By entering SF in the first attribute, action in the second attribute, and viewing rate in the third attribute, as shown in FIG. 16, the program information display means 103 draws a three-dimensional scatter diagram, plotting the SF on X-axis 1601, action on Y-axis 1602, and viewing rate on Z-axis 1603, and displays each program information in the program information display area 1611, in the place conforming to the related values about attributes. The viewing rate is indicated by the length of vertical bar displayed in the scatter diagram.

Thus, the viewer can instantly understand the three properties of the program by the three-dimensional display.

### Preferred Embodiment 7

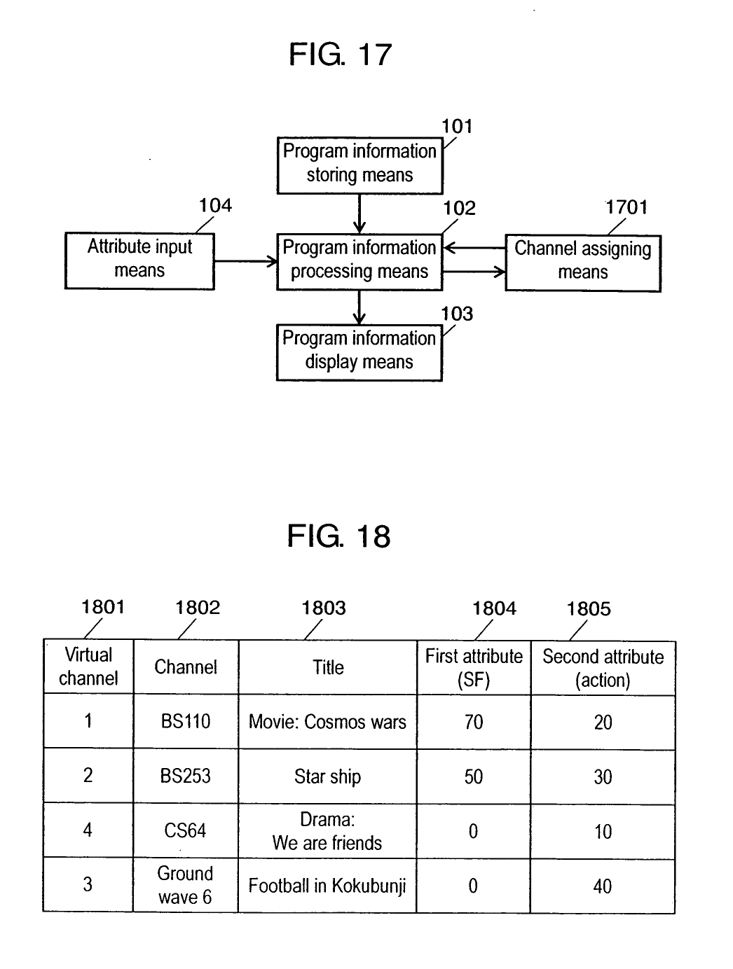

FIG. 17 is a block diagram of configuration of seventh preferred embodiment of program information display device of the invention. In FIG. 17, channel assigning means 1701 acquires program information, related value about first attribute of program information, and related value about second attribute, from the program information processing means 102. The channel assigning means 1701 sums up the related value about first attribute and related value about second attribute, assigns virtual channels in the descending order from the program information of the highest sum, and sends the result to the program information processing means 102. The program information processing means 102 acquires the virtual channels from the channel assigning means 1701, aside from the function mentioned in preferred embodiment 1 of the invention, and feeds the virtual channels in the program information acquired from the program information storing means 101, and sends out the program information, first attribute, second attribute, related value about first attribute, and related value about second attribute, to the program information display means 103. When the same numbers as virtual channels are entered from the attribute input means 104, the program information processing means 102 refers to the stored program information, and displays the program by converting to specified channels. In the seventh preferred embodiment, other configuration of the program information display device is same as in the first preferred embodiment.

FIG. 18 shows data structure of program information for displaying in the scatter diagram stored in the program information processing means 102. Program channel 1802, title 1803, related value of first attribute 1804, and related value about second attribute 1805 are acquired from the program information storing means 101. Virtual channel 1801 is acquired from the channel assigning means 1701.

In the program information display device having such configuration, operation is described below. The viewer enters two attributes desired to be displayed in scatter diagram, as first attribute and second attribute, in the program information processing means 102 through the program attribute input means 104. The program information processing means 102 acquires the first attribute and second attribute from the attribute input means 104, and acquires program information and related value about first attribute of program information, and related value about second attribute, from the program information storing means 101. The channel assigning means 1701 acquires program information, related value about first attribute of program information, and related value about second attribute, from the program information processing means 102. Further, the channel assigning means 1701 sums up the related value about first attribute and related value about second attribute of each program information, assigns virtual channels in the descending order from the program information of the highest sum, and sends the result to the program information processing means 102. The program information processing means 102 acquires the virtual channels from the channel assigning means 1701, and feeds into the virtual channel 1801 of the program information as shown in FIG. 18. The program information display means 103 acquires the program information, related value about first attribute of program information, and related value about second attribute, from the program information processing means 102, and displays a scatter diagram, plotting first attribute 1804 and second attribute 1805 on axes. The program information display means 103 displays the assigned virtual channel 1801, channel 1802, and title 1803, at positions conforming to the related value of first attribute 1804 and related value of second attribute 1805. When the viewer enters the same value as the virtual channel 1801 in the information processing means 102 through the attribute input means 104, the program information processing means 102 refers to the program information, converts to the channel 1802 corresponding to the virtual channel 1801, and displays the program. For example in FIG. 18, when “4” is entered, the channel is converted to CS64 by the program information processing means 102, and the program of drama: We are friends is selected.

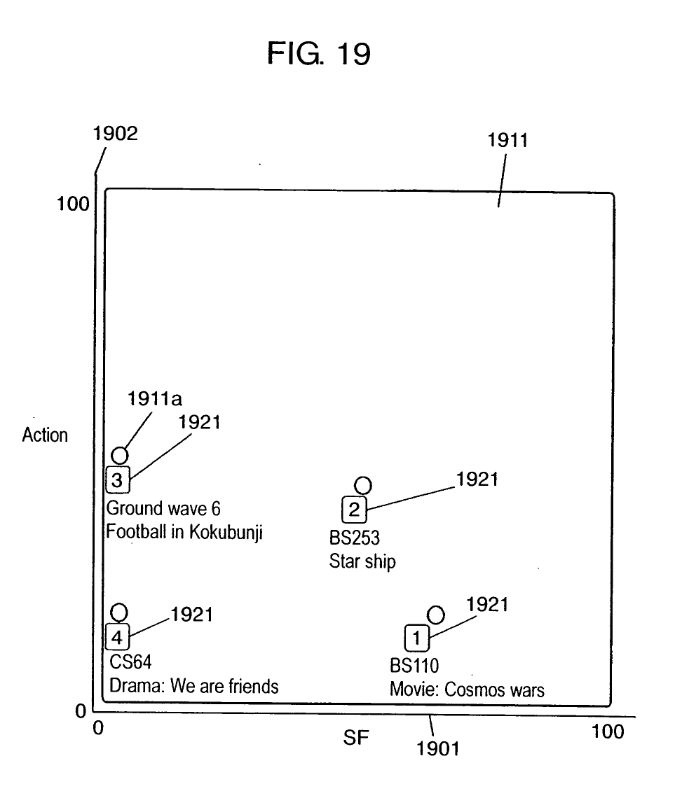

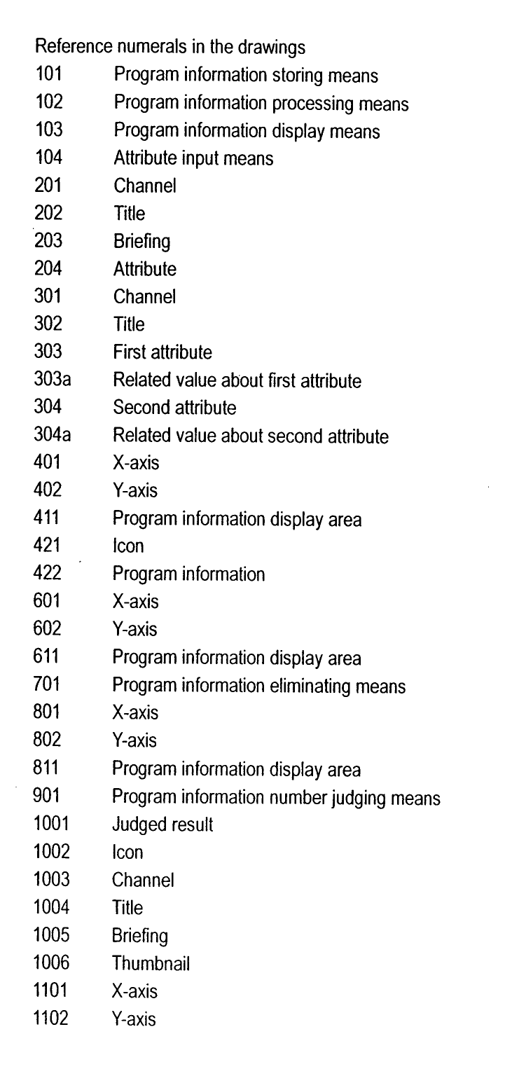

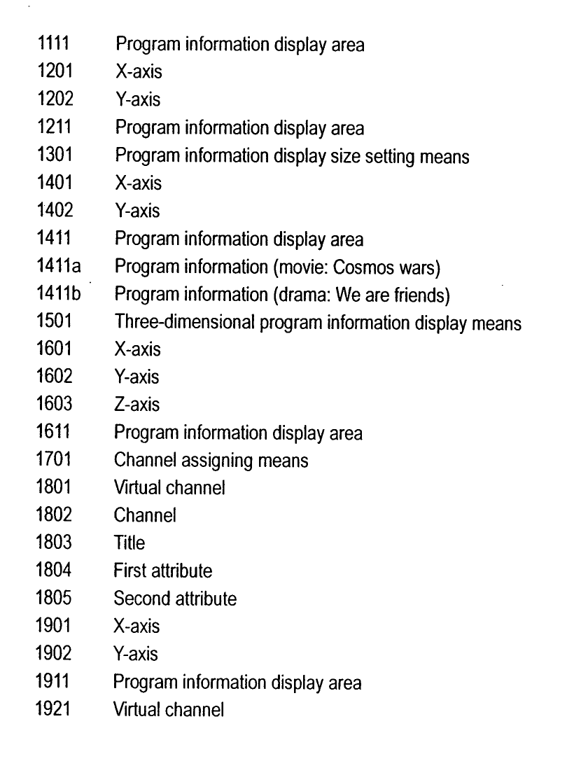

FIG. 19 is a diagram explaining the display operation of scatter diagram in the seventh preferred embodiment. By entering SF in the first attribute, and action in the second attribute, as shown in FIG. 19, the program information display means 103 compiles a scatter diagram, plotting the SF on X-axis 1901, and action on Y-axis 1902. The program information display means 103 displays the program information in the program information display area 1911, in the place conforming to the related values about attributes of the program information. At this time, the virtual channels 1921 are displayed in the descending order from the highest sum of related values of programs such as SF and action. For instance, if the viewer desired to see the movie: Football in Kokubunji, by pressing “3” on the remote controller, the program can be viewed. The combination of program information and virtual channel may be maintained for a specific time, or until the power source of the TV is cut off, or until the program corresponding to the program information is terminated. An upper limit may be provided in the number of combinations of program information and virtual channel. Assignment of virtual channels is not limited to the descending order from the highest sum of related values.

Thus, the viewer refers to the program information and virtual channel displayed in the scatter diagram, enters the number of the corresponding virtual channel by the remote controller, and selects the program. When selecting a program, the viewer can select and see the desired program easily without requiring complicated operation.

As described herein, by the program information display device of the invention, the viewer can use the electronic program guide showing arbitrary attributes plotted on axes of scatter diagram displaying the program information, and can easily find out a desired program. Further, by displaying the program information in a form of scatter diagram, an electronic program guide not restricted to discrete layout as compared with program table, and high in degree of freedom of display of program information can be presented.

### INDUSTRIAL APPLICABILITY

The program information display device of the invention can make use of the electronic program guide using arbitrary attributes as axes of scatter diagram displaying program information, and a desired program can be found out easily. Further, in the program information display device of the invention, by displaying the program information in a form of scatter diagram, an electronic program guide not restricted to discrete layout, and high in degree of freedom of display of program information can be presented.

1. A program information display device for displaying a scatter diagram by plotting two arbitrary attributes selected by the viewer from at least two attributes relating to a program on the X-axis and Y-axis, and disposing the program information at a position conforming to the related value about the X-axis attribute and the related value about the Y-axis attribute, comprising:
program information storing means;
program information processing means;
program information display means; and
attribute input means,
wherein the program information storing means stores a related value numerically expressing the degree of relation about at least one program information and at least two attributes of program information,
the attribute input means acquires a first attribute used as X-axis of scatter diagram and a second attribute used as Y-axis,
the program information processing means acquires the first attribute and the second attribute from the attribute input means, and also acquires the program information, related value about first attribute and related value about second attribute from the program information storing means, and
the program information display means acquires the program information, the first attribute, the second attribute, related value about first attribute and related value about second attribute from the program information processing means, plots the first attribute and second attribute on the X-axis and Y-axis of scatter diagram respectively, and displays the program information at a position conforming to the related value about the first attribute and the related value about the second attribute of the scatter diagram.

2. The program information display device of claim 1, wherein the program information display means displays icons, in addition to the program information, in the scatter diagram disposed at a position conforming to the related value about the X-axis and the related value about the Y-axis of the control information.

3. The program information display device of claim 1, wherein the attribute is information about program, and this information includes channel, on-air time, genre, and viewing rate.

4. The program information display device of claim 1, wherein the program information stored in the program information storing means includes thumbnail.

5. The program information display device of claim 1,
wherein the attribute input means further acquires display range of the first attribute and display range of the second attribute, and
the program information display means further acquires display range of the first attribute and display range of the second attribute from the attribute input means, plots the first attribute and second attribute on the X-axis and Y-axis of scatter diagram respectively, displays the display range of the X-axis in the display range of the first attribute, displays the display range of the Y-axis in the display range of the second attribute, and displays the program information at a position conforming to the related value about the first attribute and the related value about the second attribute of the scatter diagram.

6. The program information display device of claim 1, further comprising:
program information eliminating means,
wherein the program information storing means stores at least one program information, and related value about at least three attributes of the program information,
the attribute input means further acquires third attribute and limit value of third attribute as threshold when displaying the program information in the scatter diagram,
the program information eliminating means acquires the third attribute and limit value of the third attribute from the attribute input means, acquires the program information and related value about at least three attributes of the program information from the program information storing means, compares the related value about the third attribute of the related value about at least three attributes of the program information with the limit value of the third attribute, eliminates the program information and related value about at least three attributes of the program information when the related value about the third attribute is less than the limit value of the third attribute, and saves the program information and related value about at least three attributes of the program information when the related value about the third attribute is not less than the limit value of the third attribute, and
the program information processing means acquires the first attribute and the second attribute from the attribute input means, acquires the program information, related value about the first attribute and related value about the second attribute among the program information and related value about at least three attributes of the program information saved in the program information eliminating means, and thereby does not display the program information having related value about the third attribute less than the limit value of the third attribute in the scatter diagram.

7. The program information display device of claim 1, further comprising:
program information number judging means,
wherein the program information number judging means acquires program information from the program information processing means, judges the number of program information items, and sends the judged result to the program information processing means, and
the program information processing means acquires the judged result from the program information number judging means, determines the information quantity of program information to be sent to the program information display means on the basis of the judged result, and thereby changes the information quantity displaying the program information depending on the number of program information items displayed in the scatter diagram.

8. The program information display device of claim 1, further comprising:
program information number judging means,
wherein the program information number judging means judges the display range of program scatter diagram, and sends the judged result to the program information processing means, and
the program information processing means acquires the judged result from the program information number judging means, determines the information quantity of program information to be sent to the program information display means on the basis of the judged result, and thereby changes the information quantity displaying the program information depending on the number of program information items displayed in the scatter diagram.

9. The program information display device of claim 1, further comprising:
program information display size setting means,
wherein the program information storing means stores at least one program information and related value about at least three attributes of the program information,
the attribute input means further acquires third attribute,
the program information processing means acquires the first attribute, the second attribute and the third attribute from the attribute input means, and acquires the program information, related value about the first attribute, related value about the second attribute, and related value about the third attribute from the program information storing means,
the program information display size setting means acquires the program information, the first attribute, the second attribute, the third attribute, related value about the first attribute, related value about the second attribute, and related value about the third attribute from the program information processing means, and determines the character display size setting value of program information to be displayed in the scatter diagram from the related value about the third attribute, and
the program information display means acquires the program information, the first attribute, the second attribute, related value about the first attribute, related value about the second attribute, and the character display size setting value from the program information size setting means, plots the first attribute and the second attribute on the X-axis and Y-axis of the scatter diagram respectively, and displays the program information in the character size conforming to the display size setting value at a position conforming to the related value about the first attribute and the related value about the second attribute of the program information.

10. The program information display device of claim 1, further comprising:
program information display size setting means,
wherein the program information storing means stores at least one program information and related value about at least three attributes of the program information,
the attribute input means further acquires third attribute,
the program information processing means acquires the first attribute, second attribute and third attribute from the attribute input means, and acquires the program information, related value about the first attribute, related value about the second attribute, and related value about the third attribute from the program information storing means,
the program information display size setting means acquires the program information, the first attribute, the second attribute, the third attribute, related value about the first attribute, related value about the second attribute, and related value about the third attribute from the program information processing means, and determines the character display size setting value of program information to be displayed in the scatter diagram from the related value about the third attribute, and
the program information display means acquires the program information, the first attribute, the second attribute, related value about the first attribute, and related value about the second attribute from the program information size setting means, plots the first attribute and second attribute on the X-axis and Y-axis of the scatter diagram respectively, and displays the program information in the icon size conforming to the display size setting value at a position conforming to the related value about the first attribute and the related value about the second attribute of the program information.

11. The program information display device of claim 1,
wherein the program information display means is three-dimensional program information display means for displaying in three dimensions,
the program information storing means stores at least one program information and related value about at least three attributes of the program information,
the attribute input means further acquires third attribute as Z-axis of three-dimensional scatter diagram,
the program information processing means acquires the first attribute, second attribute and third attribute from the attribute input means, and acquires the program information, related value about the first attribute of the program information, related value about the second attribute, and related value about the third attribute from the program information storing means, and
the three-dimensional program information display means acquires the program information, the first attribute, the second attribute, the third attribute, related value about the first attribute, related value about the second attribute, and related value about the third attribute from the program information processing means, plots the first attribute, second attribute, and third attribute on the X-axis, Y-axis, and Z-axis of the three-dimensional scatter diagram respectively, and displays the program information at a position conforming to the related value about the first attribute, the related value about the second attribute, and the related value about the third attribute of the program information.

12. The program information display device of claim 1, further comprising:
channel assigning means,
wherein the program information processing means acquires first attribute and second attribute from the attribute input means, and acquires program information, related value about the first attribute of the program information, and related value about the second attribute from the program information storing means,
the channel assigning means acquires the program information, related value about the first attribute of the program information, and related value about the second attribute from the program information processing means, and determines virtual channels to be assigned in the program information from the related value,
the program information processing means acquires the virtual channels from the channel assigning means, and
the program information display means acquires the program information, the virtual channels of the program information, the first attribute, the second attribute, related value about the first attribute, and related value about the second attribute from the program information processing means, plots the first attribute and second attribute on the X-axis and Y-axis of the scatter diagram respectively, and displays the program information and the virtual channels at a position conforming to the related value about the first attribute and the related value about the second attribute.

13. The program information display device of claim 12,
wherein the channel assigning means sums up the related value about the first attribute of the program information and related value about the second attribute, and determines the virtual channel to be assigned in the ascending order or the descending order from the program information of the highest sum.

14. The program information display device of claim 12,
wherein the program information processing means maintains the combination of program information and assigned virtual channels until the specified condition is satisfied.

15. The program information display device of claim 14,
wherein the program information processing means maintains the combination of program information and assigned virtual channels for a specific time.

16. The program information display device of claim 14,
wherein the program information processing means maintains the combination of program information and assigned virtual channels until the power is cut off.

17. The program information display device of claim 14,
wherein the program information processing means maintains the combination of program information and assigned virtual channels by a specific number.

18. The program information display device of claim 14,
wherein the program information processing means maintains the combination of program information and assigned virtual channels until the program corresponding to the program information is terminated.

19. The program information display device of claim 12,
wherein the attribute input means acquires the same channel as the virtual channel displayed in the program information display means when the viewer selects a program, and
the program information processing means acquires the channel from the attribute input means, acquires the specified channel corresponding to the virtual channel from the program information, and displays the program on the screen by using the specified channel.
